(19) United States
(12) Patent Application Publication
(10) Pub. No.: US 2017/0173847 A1
(43) Pub. Date: Jun. 22, 2017

(54) Thermoforming of Dynamic Cross-Linked Polymer Compositions

(71) Applicant: SABIC Global Technologies B.V., Bergen op Zoom (NL)

(72) Inventors: Ramon Groote, Oisterwijk (NL); Chiel Albertus Leenders, Fijnaart (NL); Ad Laanen, Lepelstraat (NL)

(21) Appl. No.: 15/325,989

(22) PCT Filed: Jul. 16, 2015
(86) PCT No.: PCT/IB2015/055409

§ 371 Date: Jan. 12, 2017

Related U.S. Application Data
(60) Provisional application No. 62/026,454, filed on Jul. 18, 2014.

(51) Int. Cl. B29C 51/10; C08G 63/183; C08G 63/46; B29C 51/00; B29C 43/00

(52) U.S. Cl. CPC B29C 51/10; B29C 51/002; B29C 43/003; C08G 63/46; C08G 63/183; B29K 2063/00

(57) ABSTRACT

Methods of thermoforming dynamic cross-linked polymer compositions are described.

### CROSS REFERENCE TO RELATED APPLICATIONS

This application claims the benefit of U.S. Provisional Application No. 62/026,454, filed Jul. 18, 2014, the entirety of which is incorporated by reference herein.

### BACKGROUND

Described herein are methods of thermoforming dynamic cross-linked polymer compositions.

While dynamic cross-linked polymer compositions prepared by combining epoxides and carboxylic acids in the presence of a transesterification catalyst have been described, there have been no reports regarding whether these materials can be thermoformed using traditional compression molding or vacuum thermoforming techniques.

Accordingly, there remains a need in the art for methods of thermoforming dynamic cross-linked polymer compositions.

### SUMMARY

The above-described and other deficiencies of the art are met by methods for forming a compression molded article. comprising introducing a polymer composition that is a dynamic, or pre-dynamic, cross-linked polymer composition into a compaction device comprising a compression mold; and subjecting the dynamic cross-linked polymer composition in the compression mold to a pressure of about 1 to about 50 tons per square centimeter at a temperature of about 0 to about 70° C. to form the compression molded article.

Described herein are methods of forming a vacuum thermoformed article comprising feeding a sheet comprising a polymer composition that is a dynamic, or pre-dynamic, cross-linked polymer composition to a mold; heating the sheet for up to about 120 seconds; and applying a vacuum to the heated sheet to form the vacuum thermoformed article.

Articles prepared using the methods described herein are also described.

The above described and other features are exemplified by the following detailed description, examples, and claims.

### DETAILED DESCRIPTION

Described herein are methods of forming compression molded articles from dynamic, or pre-dynamic, cross-linked polymer compositions. Also described are methods for forming vacuum thermoformed articles from dynamic cross-linked polymer compositions.

The present disclosure can be understood more readily by reference to the following detailed description of desired embodiments and the examples included therein. In the following specification and the claims that follow, reference will be made to a number of terms which have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. “Or” means “and/or.” As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that can contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

As used herein, “Tm” refers to the melting temperature at which a polymer completely loses its orderly arrangement. As used herein, “Tc” refers to the crystallization temperature at which a polymer gives off heat to break a crystalline arrangement. The terms “glass transition temperature” or “Tg” refer to the maximum temperature at which a polymer will still have one or more useful properties. These properties include impact resistance, stiffness, strength, and shape retention. The Tg therefore can be an indicator of its useful upper temperature limit, particularly in plastics applications. The Tg can be measured using a differential scanning calorimetry method and expressed in degrees Celsius. The glass transition temperatures (Tg) described herein are measures of heat resistance of, for example, polyester composition. Preferably, dynamic cross-linked compositions described herein have Tg of about 40 to about 60° C.

As used herein, “crosslink,” and its variants, refers to the formation of a stable covalent bond between two polymers. This term is intended to encompass the formation of covalent bonds that result in network formation which in the current system, is preceded by chain extension. The term “cross-linkable” refers to the ability of a polymer to form such stable covalent bonds.

“Dynamic cross-linked polymer compositions” have dynamically, covalently cross-linked polymer networks. At low temperatures, dynamic cross-linked polymer compositions behave like classic thermosets, but at elevated temperatures, for example, temperatures up to about 320° C., it is believed that the cross-links undergo bond exchange reactions, e.g., transesterification reactions. At those elevated temperatures, the transesterification happens at such a rate that flow-like behavior is observed and the material can be processed. Without being bound by any theory, at higher temperatures it is theorized that the cross-links have dynamic mobility, resulting in a flow-like behavior that enables the composition to be processed and re-processed. Dynamic cross-linked polymer compositions incorporate covalently crosslinked networks that are able to change their topology through thermoactivated bond exchange reactions. The network is capable of reorganizing itself without altering the number of cross-links between its polymer chains. At high temperatures, dynamic cross-linked polymer compositions can achieve transesterification rates that permit mobility between crosslinks, so that the network behaves like a soft material, e.g., flexible rubber. At low temperatures, exchange reactions are very long (slow), and dynamic cross-linked polymer compositions behave like classical thermosets. The transition from the liquid to the solid is reversible and exhibits a glass transition. Put another way, dynamic cross-linked polymer compositions can be heated to temperatures such that they become moldable or liquid without suffering destruction or degradation of their structure. The viscosity of these materials varies slowly over a broad temperature range, with behavior that approaches the Arrhenius law. Because of the presence of the crosslinks, a dynamic cross-linked polymer composition will not lose integrity above the glass transition temperature (Tg) or the melting temperature (Tm) like a thermoplastic will. An article made from a dynamic cross-linked polymer composition can be heated and deformed, and upon returning to the original temperature, maintains the deformed shape. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; D. Montarnal et al., Science 334 (2011) 965-968; and J. P. Brutman et al, ACS Macro Lett. 2014, 3, 607-610.

As used herein, “pre-dynamic cross-linked polymer composition” refers to a mixture comprising all the required elements to form a dynamic cross-linked polymer composition, but which has not been cured sufficiently to establish the requisite level of cross-linking for forming a dynamic cross-linked polymer composition. Upon sufficient curing, for example, heating to temperatures up to about 320° C., a pre-dynamic cross-linked polymer composition will convert to a dynamic cross-linked polymer composition. Polymer compositions that can be used as dynamic, or pre-dynamic, cross-linked polymer compositions preferably comprise an epoxy-containing component, a polyester component, and a transesterification catalyst, as well as optional additives.

In preferred methods, a compression molded article is formed by a method comprising introducing a polymer composition that is dynamic cross-linked polymer composition or a pre-dynamic polymer composition into a compaction device comprising a compression mold and subjecting the polymer composition in the compression mold to a temperature of about 0 to about 100° C. above the glass transition or melting temperature of the polymer composition. For example, a compression molded article is formed by a method comprising introducing a dynamic cross-linked polymer composition into a compaction device comprising a compression mold and subjecting the dynamic cross-linked polymer composition in the compression mold to a temperature of about 0 to about 100° C. above the glass transition or melting temperature of the dynamic cross-linked polymer composition. In another example, a compression molded article is formed by a method comprising introducing a pre-dynamic cross-linked polymer composition into a compaction device comprising a compression mold and subjecting the pre-dynamic cross-linked polymer composition in the compression mold to a temperature of about 0 to about 100° C. above the glass transition or melting temperature of the dynamic cross-linked polymer composition or the pre-dynamic cross-linked polymer composition. In preferred embodiments, the polymer composition, that is, the dynamic cross-linked polymer composition or the pre-dynamic cross-linked polymer composition, is produced by combining an epoxy-containing component, a polyester component or a carboxylic acid component, and a transesterification catalyst.

In exemplary embodiments, the compression molded article is then fully cured by, for example, applying heat to the article. Preferred temperatures include temperatures up to about 320° C., for example, about 250 to about 320° C. Preferably, the compression molded article is cured by heating the article to a temperature of about 250, about 260, about 270, about 280, about 290, about 300, about 310, or about 320° C.

In some embodiments, the dynamic cross-linked polymer composition or the pre-dynamic polymer composition is produced by combining an epoxy-containing component; a carboxylic acid component; and a transesterification catalyst. In other embodiments, the dynamic cross-linked polymer composition or the pre-dynamic polymer composition is produced by combining an epoxy-containing component; a polyester component; and a transesterification catalyst. Each of these components is more fully described herein.

Described herein are methods of forming a vacuum thermoformed article comprising feeding a sheet comprising a polymer composition that is a dynamic cross-linked polymer composition or a pre-dynamic polymer composition to a mold; heating the sheet for up to about 120 seconds; and applying a vacuum to the heated sheet to form the vacuum thermoformed article. For example, in one embodiment of the disclosure, a vacuum thermoformed article is produced by feeding a sheet comprising a dynamic cross-linked polymer composition to a mold; heating the sheet for up to about 120 seconds; and applying a vacuum to the heated sheet to form the vacuum thermoformed article. In another embodiment, a vacuum thermoformed article is produced by feeding a sheet comprising a pre-dynamic cross-linked polymer composition to a mold; heating the sheet for up to about 120 seconds; and applying a vacuum to the heated sheet to form the vacuum thermoformed article.

In some embodiments, the sheet is heated to a temperature of up to about 200° C. For example, in preferred embodiments, the sheet is heated to a temperature of about 120° C. to about 200° C., for example, about 170 to about 200° C. Preferably, the sheet is heated to a temperature of about 120, about 130, about 140, about 150, about 160, about 170, about 180, about 190, or about 200° C.

In some embodiments, the sheet is heated for between about 5 and about 120 seconds, for example, between about 5 and about 100 seconds, between about 5 and about 90 seconds, between about 5 and about 60 seconds, or between about 5 and 45 seconds. In preferred embodiments, the sheet is heated for between about 5 and about 60 seconds.

In some embodiments, the polymer composition used in the thermoforming methods, that is, the dynamic cross-linked polymer composition or the pre-dynamic polymer composition, is produced by combining an epoxy-containing component; a carboxylic acid component; and a transesterification catalyst. In other embodiments, the polymer compositions used in the thermoforming methods, that is, the dynamic cross-linked polymer composition or the pre-dynamic polymer composition, is produced by combining an epoxy-containing component; a polyester component; and a transesterification catalyst. Each of these components is more fully described below. The polymer compositions can be prepared using methods known in the art. Alternatively, the polymer compositions can be prepared according to the methods described in U.S. Provisional Application No. 62/026,458, filed Jul. 18, 2014, the entirety of which is incorporated herein by reference.

The epoxy-containing component can be a monomer, an oligomer, or a polymer. Generally, the epoxy-containing component has at least two epoxy groups, and can also include other functional groups as desired, for example, hydroxyl (—OH). Glycidyl epoxy resins are a particularly preferred epoxy-containing component. An exemplary glycidyl epoxy ether is bisphenol A diglycidyl ether (BADGE), which can be considered a monomer, oligomer or polymer, and is shown below as Formula (A).

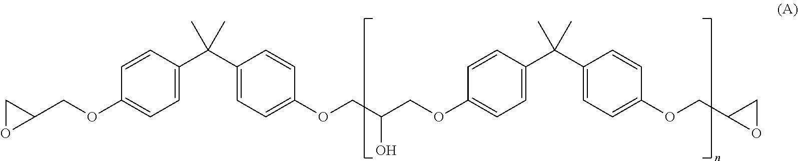

The value of n can be from 0 to about 25 in Formula (A). When n=0, this is a monomer. When n=1 to 7, this is an oligomer. When n=8 to about 25, this is a polymer. BADGE-based resins have excellent electrical properties, low shrinkage, good adhesion to numerous metals, good moisture resistance, good heat resistance and good resistance to mechanical impacts. BADGE oligomers (where n=1 or 2) are commercially available as D.E.R. 671 from Dow, which has an epoxide equivalent of 475-550 grams/equivalent, 7.8-9.4% epoxide, 1820-2110 mmol of epoxide/kilogram, a melt viscosity at 150° C. of 400-950 mPa·sec, and a softening point of 75-85° C.

Novolac resins can be used. These epoxy resins are obtained by reacting phenol with formaldehyde in the presence of an acid catalyst to produce a novolac phenolic resin, followed by a reaction with epichlorohydrin in the presence of sodium hydroxide as catalyst. Epoxy resins are illustrated as Formula (B):

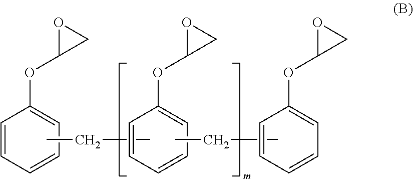

wherein m is has a value from 0 to about 25.

Another useful epoxide is depicted in Formula C.

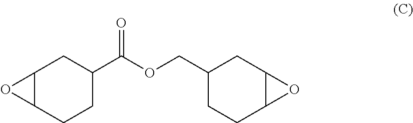 [SMILES: O=C(OCC1CCC2OC2C1)C1CCC2OC2C1]

Another useful epoxide is available under the trade name ARALDITE PT910, which is a combination of bifunctional and trifunctional aromatic glycidyl esters as shown in Formulas D1 and D2.

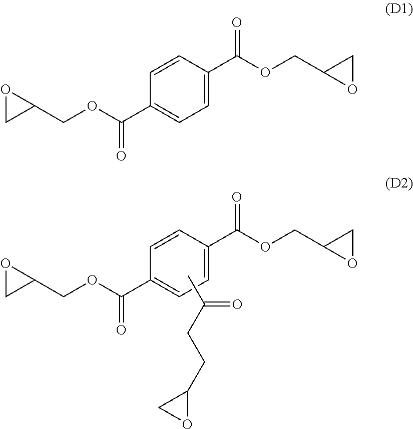

Regarding the carboxylic acid component, carboxylic acids react with epoxide groups to form esters. The presence of at least two carboxylic acid moieties allows crosslinking of the dynamic cross-linked polymer compositions described herein. Carboxylic acid components comprising at least three carboxylic acid moieties enable the formation of a three-dimensional network.

The preparation of the compositions described herein can be performed with one or more carboxylic acid components, including at least one of the polyfunctional carboxylic acid type. Advantageously, the carboxylic acid component is chosen from carboxylic acids in the form of a mixture of fatty acid dimers and trimers comprising 2 to 40 carbon atoms.

Preferred carboxylic acid components can comprise 2 to 40 carbon atoms, such as linear diacids (glutaric, adipic, pimelic, suberic, azelaic, sebacic or dodecanedioic and homologues thereof of higher masses) and also mixtures thereof, or fatty acid derivatives thereof. It is preferred to use trimers (oligomers of 3 identical or different monomers) and mixtures of fatty acid dimers and trimers, in particular of plant origin. These compounds result from the oligomerization of unsaturated fatty acids such as: undecylenic, myristoleic, palmitoleic, oleic, linoleic, linolenic, ricinoleic, eicosenoic, or docosenoic acid, which are usually found in pine oil, rapeseed oil, corn oil, sunflower oil, soybean oil, grapeseed oil, linseed oil, and jojoba oil, and also eicosapentaenoic acid and docosahexaenoic acid, which are found in fish oils.

Also preferred are aromatic carboxylic acid components comprising 6 to 40 carbon atoms, like aromatic diacids such as phthalic acid, trimellitic acid, terephthalic acid, and naphthalenedicarboxylic acid.

Examples of fatty acid trimers include the compounds of the following formulae that illustrate cyclic trimers derived from fatty acids containing 18 carbon atoms. The compounds that are commercially available are mixtures of steric isomers and of positional isomers of these structures, which are optionally partially or totally hydrogenated.

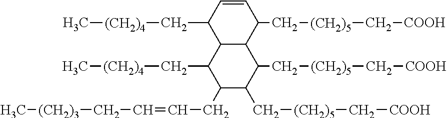

A mixture of fatty acid oligomers containing linear or cyclic C₁₈ fatty acid dimers, trimers and monomers, the mixture predominantly being dimers and trimers and containing a small percentage (usually less than about 5%) of monomers, can thus be used. Preferably, the mixture comprises:
about 0.1% to 40% by weight and preferably about 0.1% to about 5% by weight of identical or different fatty acid monomers,
about 0.1% to about 99% by weight and preferably about 18% to about 85% by weight of identical or different fatty acid dimers, and
about 0.1% to about 90% by weight and preferably about 5% to about 85% by weight of identical or different fatty acid trimers.
   Examples of fatty acid dimers/trimers include the following (weight %):
PRIPOL® 1017 from Uniqema or Croda, mixture of 75-80% dimers and 18-22% trimers with about 1-3% fatty acid monomers,
PRIPOL® 1048 from Uniqema or Croda, 50/50% mixture of dimers/trimers,
PRIPOL® 1013 from Uniqema or Croda, mixture of 95-98% dimers and about 2-4% trimers with 0.2% maximum of fatty acid monomers,
PRIPOL® 1006 from Uniqema or Croda, mixture of 92-98% dimers and a maximum of 4% trimers with 0.4% maximum of fatty acid monomers,
PRIPOL® 1040 from Uniqema or Croda, mixture of fatty acid dimers and trimers with at least 75% trimers and less than 1% fatty acid monomers,
UNIDYME® 60 from Arizona Chemicals, mixture of 33% dimers and 67% trimers with less than 1% fatty acid monomers,
UNIDYME® 40 from Arizona Chemicals, mixture of 65% dimers and 35% trimers with less than 1% fatty acid monomers,
UNIDYME® 14 from Arizona Chemicals, mixture of 94% dimers and less than 5% trimers and other higher oligomers with about 1% fatty acid monomers,
EMPOL® 1008 from Cognis, mixture of 92% dimers and 3% higher oligomers, essentially trimers, with about 5% fatty acid monomers,
EMPOL® 1018 from Cognis, mixture of 81% dimers and 14% higher oligomers, essentially trimers, with about 5% fatty acid monomers,
RADIACID® 0980 from Oleon, mixture of dimers and trimers with at least 70% trimers.

The products PRIPOL®, UNIDYME®, EMPOL® and RADIACID® comprise C₁₈ fatty acid monomers and fatty acid oligomers corresponding to multiples of C₁₈.

Other preferred carboxylic acid components include polyoxyalkylenes (polyoxyethylene, polyoxypropylene, etc.) comprising carboxylic acid functional groups, preferably terminal (at the ends), phosphoric acid, and other polymers, such as polyesters and polyamides, with a branched or unbranched structure, comprising terminal carboxylic acid functional groups.

Preferably, the carboxylic acid component comprises fatty acid dimers and trimers or polyoxyalkylenes comprising terminal carboxylic acid functional groups.

The carboxylic acid component can also be in the form of an anhydride. Preferred anhydrides include cyclic anhydrides, for instance phthalic anhydride, methylnadic anhydride, hexahydrophthalic anhydride, dodecylsuccinic anhydride, or glutaric anhydride. Other preferred anhydrides include succinic anhydride, maleic anhydride, chlorendic anhydride, nadic anhydride, tetrachlorophthalic anhydride, pyromellitic dianhydride, 1,2,3,4-cyclopentanetetracarboxylic acid dianhydride, or aliphatic acid polyanhydrides such as polyazelaic polyanhydride and polysebacic polyanhydride.

By using an equimolar ratio between the hydroxyl/epoxy groups of the epoxy-containing component and the carboxylic acid groups of the carboxylic acid component, a moderately crosslinked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of carboxylic acid groups.

Also present in the compositions described herein are polymers that have ester linkages, i.e., polyesters. “Polyesters” as used herein includes polymers that contain only ester linkages between monomers, and that can have the same or different ester units, as well as copolymers containing ester linkages between units and potentially other linkages (e.g., carbonate linkages) as well.

The polyester can be a poly(alkylene terephthalate), for example a poly(C₁₋₈alkylene terephthalate). An example is poly(butylene terephthalate), also known as PBT, which has the structure shown below:

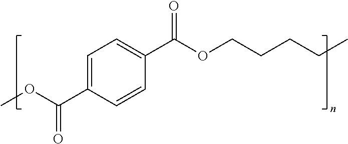

where n is the degree of polymerization, and can be as high as about 1,000. The polyester can have a weight average molecular weight of up to about 100,000 Daltons.

The polyester can be, for example, poly(propylene terephthalate), also known as PPT, or poly(ethylene terephthalate), also known as PET. PET has the structure shown below:

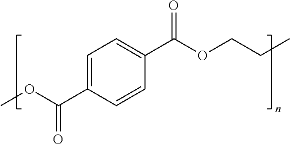

where n is the degree of polymerization, and can be as high as about 1,000, and the polymer can have a weight average molecular weight of up to about 100,000 Daltons.

The polyester can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a polyester having the structure shown below:

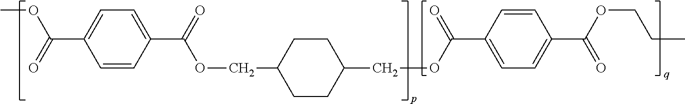

where p is the molar percentage of repeating units derived from CHDM, q is the molar percentage of repeating units derived from ethylene glycol, and p>q, and the polymer can have a weight average molecular weight of up to about 100,000. Alternatively, the poly can be PETG. PETG has the same structure as PCTG, except that the ethylene glycol is 50 mole % or more of the diol content. PETG is an abbreviation for polyethylene terephthalate, glycol-modified.

The polyester can be poly(1,4-cyclohexane-dimethanol-1,4-cyclohexanedicarboxylate), i.e., PCCD, which is a polyester formed from the reaction of CHDM with dimethyl cyclohexane-1,4-dicarboxylate. PCCD has the structure shown below:

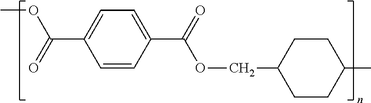

where n is the degree of polymerization, and can be as high as about 1,000, and the polymer can have a weight average molecular weight of up to about 100,000 Daltons.

The polymer having ester linkages can be poly(ethylene naphthalate), also known as PEN, which has the structure shown below:

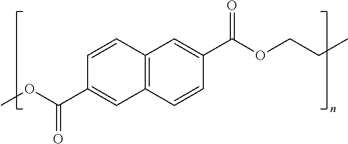

where n is the degree of polymerization, and can be as high as about 1,000, and the polymer can have a weight average molecular weight of up to about 100,000 Daltons.

The polyester can also be a copolyestercarbonate. A copolyestercarbonate contains two sets of repeating units, one having carbonate linkages and the other having ester linkages. This is illustrated in the structure below:

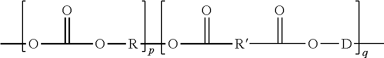

where p is the molar percentage of repeating units having carbonate linkages, q is the molar percentage of repeating units having ester linkages, and p+q=100%; and R, R′, and D are independently divalent radicals.

The divalent radicals R, R′ and D can be made from any combination of aliphatic or aromatic radicals, and can also contain other heteroatoms, such as oxygen, sulfur, or halogen. R and D are generally derived from dihydroxy compounds, such as the bisphenols of Formula (A). In particular embodiments, R is derived from bisphenol-A. R′ is generally derived from a dicarboxylic acid. Exemplary dicarboxylic acids include isophthalic acid; terephthalic acid; 1,2-di(p-carboxyphenyl)ethane; 4,4′-dicarboxydiphenyl ether; 4,4′-bisbenzoic acid; 1,4-, 1,5-, or 2,6-naphthalenedicarboxylic acids; and cyclohexane dicarboxylic acid. As additional examples, the repeating unit having ester linkages can be butylene terephthalate, ethylene terephthalate, PCCD, or ethylene naphthalate as depicted above.

Aliphatic polyesters can also be used. Examples of aliphatic polyesters include polyesters having 1 or more, and up to about 1,000 repeating units of the following formula:

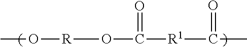

where at least one R or R¹ is an alkyl-containing radical. In some embodiments, at least one R or R¹ is a C₁₋₁₈ alkylene, and in preferred embodiments, at least one of the R1 is C₄₋₁₈ alkylene. These can be prepared from the polycondensation of glycol and an aliphatic dicarboxylic acid, in particular a C₄₋₁₈ alkylene dicarboxylic acid such as sebacic acid.

By using an equimolar ratio between the hydroxyl/epoxy groups of the epoxy-containing component and the ester groups of the polymer having ester linkages, a moderately crosslinked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of ester groups.

The mole ratio of hydroxyl/epoxy groups (from the epoxy-containing component) to the ester groups (from the polymer having ester linkages) in the system is generally from about 1:100 to about 5:100.

Certain transesterification catalysts can be used to catalyze the reactions described herein. The transesterification catalyst is used in an amount up to about 25 mol %, for example, about 0.025 mol % to about 25 mol %, based on the total molar amount of carboxylic acid groups or ester groups in the polyester. In some embodiments, the transesterification catalyst is used in an amount of from about 0.025 mol % to about 10 mol % or from about 1 mol % to less than about 5 mol % based on the total molar amount of carboxylic acid groups or ester groups in the polyester. Preferred embodiments include about 0.025, about 0.05, about 0.1, about 0.2 mol % of catalyst, based on the total molar amount of carboxylic acid or ester groups in the polyester. Alternatively, the catalyst is used in an amount of from about 0.1% to about 10% by mass relative to the total mass of the reaction mixture, and preferably from about 0.5% to about 5%.

Transesterification catalysts are known in the art and are usually chosen from metal salts, for example, acetylacetonates, of metals such as zinc, tin, magnesium, cobalt, calcium, titanium, and zirconium.

Tin compounds such as dibutyltin laurate, tin octanoate, dibutyltin oxide, dioctyltin, dibutyldimethoxytin, tetraphenyltin, tetrabutyl-2,3-dichlorodistannoxane, and all other stannoxanes are envisioned as suitable catalysts.

Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used.

Salts of saturated or unsaturated fatty acids and metals, alkali metals, alkaline earth and rare earth metals, for example zinc stearate, are also envisioned as suitable catalysts.

Other catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, para-toluene sulfonic acid; phosphines such as triphenylphosphine, dimethylphenylphosphine, methyldiphenylphosphine, tri-t-butylphosphine; and phosphazenes.

The catalyst can also be an organic compound, such as benzyldimethylamide or benzyltrimethyl ammonium chloride. These catalysts are generally in solid form, and advantageously in the form of a finely divided powder. A preferred catalyst is zinc(II)acetylacetonate.

Suitable transesterification catalysts are also described in Otera, J. Chem. Rev. 1993, 93, 1449-1470. Tests for determining whether a catalyst will be appropriate for a given polymer system within the present scope are described in, for example, U.S. Published Application No. 2011/0319524 and WO 2014/086974.

Other additives can be present in the compositions described herein, as desired. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, metals, nucleating agents, and clarifying agents, and combinations thereof.

Exemplary polymers that can be mixed with the compositions described herein include elastomers, thermoplastics, thermoplastic elastomers, and impact additives. The compositions can be mixed with other polymers such as a polyester, a polyestercarbonate, a bisphenol-A homopolycarbonate, a polycarbonate copolymer, a tetrabromo-bisphenol A polycarbonate copolymer, a polysiloxane-co-bisphenol-A polycarbonate, a polyesteramide, a polyimide, a polyetherimide, a polyamideimide, a polyether, a polyethersulfone, a polyepoxide, a polylactide, a polylactic acid (PLA), an acrylic polymer, polyacrylonitrile, a polystyrene, a polyolefin, a polysiloxane, a polyurethane, a polyamide, a polyamideimide, a polysulfone, a polyphenylene ether, a polyphenylene sulfide, a polyether ketone, a polyether ether ketone, an acrylonitrile-butadiene-styrene (ABS) resin, an acrylic-styrene-acrylonitrile (ASA) resin, a polyphenylsulfone, a poly(alkenylaromatic) polymer, a polybutadiene, a polyacetal, a polycarbonate, an ethylene-vinyl acetate copolymer, a polyvinyl acetate, a liquid crystal polymer, an ethylene-tetrafluoroethylene copolymer, an aromatic polyester, a polyvinyl fluoride, a polyvinylidene fluoride, a polyvinylidene chloride, tetrafluoroethylene, or any combination thereof.

The additional polymer can be an impact modifier, if desired. Suitable impact modifiers can be high molecular weight elastomeric materials derived from olefins, monovinyl aromatic monomers, acrylic and methacrylic acids and their ester derivatives, as well as conjugated dienes that are fully or partially hydrogenated. The elastomeric materials can be in the form of homopolymers or copolymers, including random, block, radial block, graft, and core-shell copolymers.

A specific type of impact modifier can be an elastomer-modified graft copolymer comprising (i) an elastomeric (i.e., rubbery) polymer substrate having a Tg less than about 10° C., less than about 0° C., less than about −10° C., or between about −40° C. to about −80° C., and (ii) a rigid polymer grafted to the elastomeric polymer substrate. Materials suitable for use as the elastomeric phase include, for example, conjugated diene rubbers, for example polybutadiene and polyisoprene; copolymers of a conjugated diene with less than about 50 wt % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁-C₈ alkyl(meth)acrylates; elastomeric copolymers of C₁-C₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific impact modifiers include styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), styrene-acrylonitrile (SAN), and ethylene-acrylic ester-glycidyl methacrylate (e.g., ethylene-ethyl acrylate-glycidyl methacrylate).

The compositions described herein can comprise a UV stabilizer for dispersing UV radiation energy. The UV stabilizer does not substantially hinder or prevent cross-linking of the various components of the compositions described herein. UV stabilizers can be hydroxybenzophenones; hydroxyphenyl benzotriazoles; cyanoacrylates; oxanilides; or hydroxyphenyl triazines. Specific UV stabilizers include poly[(6-morphilino-s-triazine-2,4-diyl)[2,2,6,6-tetramethyl-4-piperidyl) imino]-hexamethylene [(2,2,6,6-tetramethyl-4-piperidyl)imino], 2-hydroxy-4-octyloxybenzophenone (Uvinul®3008); 6-tert-butyl-2-(5-chloro-2H-benzotriazole-2-yl)-4-methylphenyl (Uvinul® 3026); 2,4-di-tert-butyl-6-(5-chloro-2H-benzotriazole-2-yl)-phenol (Uvinul®3027); 2-(2H-benzotriazole-2-yl)-4,6-di-tert-pentylphenol (Uvinul®3028); 2-(2H-benzotriazole-2-yl)-4-(1,1,3,3-tetramethylbutyl)-phenol (Uvinul® 3029); 1,3-bis[(2′-cyano-3′,3′-diphenylacryloyl)oxy]-2,2-bis-{[(2′-cyano-3′,3′-diphenylacryloyl)oxy]methyl}-propane (Uvinul® 3030); 2-(2H-benzotriazole-2-yl)-4-methylphenol (Uvinul® 3033); 2-(2H-benzotriazole-2-yl)-4,6-bis(1-methyl-1-phenyethyl) phenol (Uvinul® 3034); ethyl-2-cyano-3,3-diphenylacrylate (Uvinul® 3035); (2-ethylhexyl)-2-cyano-3,3-diphenylacrylate (Uvinul® 3039); N,N′-bisformyl-N,N′-bis (2,2,6,6-tetramethyl-4-piperidinyl)hexamethylenediamine (Uvinul® 4050H); bis-(2,2,6,6-tetramethyl-4-pipieridyl)-sebacate (Uvinul® 4077H); bis-(1,2,2,6,6-pentamethyl-4-piperdiyl)-sebacate+methyl-(1,2,2,6,6-pentamethyl-4-piperidyl)-sebacate (Uvinul® 4092H); or combinations thereof. Other UV stabilizers include Cyasorb 5411, Cyasorb UV-3638, Uvinul 3030, and/or Tinuvin 234.

The compositions described herein can comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof.

The compositions described herein can comprise an antistatic agent. Examples of monomeric antistatic agents can include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents can include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT® 6321 (Sanyo) or PEBAX® MH1657 (Atofina), IRGASTAT® P18 and P22 (Ciba-Geigy). Other polymeric materials can be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing can be included to render the compositions described herein electrostatically dissipative.

The compositions described herein can comprise anti-drip agents. The anti-drip agent can be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise about 50 wt % PTFE and about 50 wt % SAN, based on the total weight of the encapsulated fluoropolymer. The SAN can comprise, for example, about 75 wt % styrene and about 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

The compositions described herein can comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments can represent from about 0.05% to 15% by weight relative to the weight of the overall composition.

The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) can also be envisaged.

Pigments, dyes or fibers capable of absorbing radiation can be used to ensure the heating of an article based on the compositions described herein when heated using a radiation source such as a laser, or by the Joule effect, by induction or by microwaves. Such heating can allow the use of a process for manufacturing, transforming or recycling an article made of the compositions described herein.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO2, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which can include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Various types of flame retardants can be utilized as additives. In one embodiment, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. Rimar salt and KSS and NATS, alone or in combination with other flame retardants, are particularly useful in the compositions disclosed herein. In certain embodiments, the flame retardant does not contain bromine or chlorine.

The flame retardant additives can include organic compounds that include phosphorus, bromine, and/or chlorine. In certain embodiments, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

Some suitable polymeric or oligomeric flame retardants include: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; 2,2-bis-(3,5-dichloro-4-hydroxyphenyl)-propane; and 2,2-bis-(3-bromo-4-hydroxyphenyl)-propane. Other flame retardants include: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“IRGAFOS 168” or “1-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

Articles can be formed from the compositions described herein. Generally, the epoxy component, the carboxylic acid or polyester components, and the transesterification catalyst are combined, e.g., mixed, to form the compositions described herein. The compositions described herein can then formed, shaped, molded, or extruded into a desired shape. Energy is subsequently applied to cure the compositions described herein to form the dynamic cross-linked polymer compositions of the disclosure. For example, the compositions can be heated to a temperature of from about 50° C. to about 250° C. to effect curing (hardening). The cooling of the hardened compositions is usually performed by leaving the material to return to room temperature, with or without use of a cooling means such as a fan, blower, refrigerator, or the like. This process is advantageously performed in conditions such that the gel point is reached or exceeded by the time the cooling is completed. More specifically, sufficient energy should be applied during hardening for the gel point of the composition to be reached or exceeded.

The term “article” refers to the compositions described herein being formed into a particular shape. For example, preferred articles that can be produced according to the methods of the disclosure include, but are not limited to, complex shapes for automotive parts (e.g., hoods, fenders, spoilers, panels, interior parts), train seating components, airplane seating components, household appliance bodies, components for building and construction (e.g., large panels, wall parts, interior applications), and articles for packaging (e.g., drinking cups, food containers, liquid drums.

With thermosetting resins of the prior art, once the resin has hardened (i.e., reached or exceeded the gel point), the article can no longer be transformed, repaired, or recycled. Applying a moderate temperature to such an article does not lead to any observable or measurable transformation, and the application of a very high temperature leads to degradation of the article. In contrast, articles formed from the dynamic cross-linked polymer compositions described herein, on account of their particular composition, can be transformed, repaired, welded together, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to the products of Diels-Alder reactions, no depolymerization is observed at high temperatures, and the material conserves its crosslinked structure. This property allows the repair of an article, for example the repair of two parts that have separated. No mold is necessary to maintain the shape of the parts during the repair process at high temperatures. Similarly, articles can be transformed by application of a mechanical force to only one part of an article without the need for a mold, since the material does not flow.

Raising the temperature of the article can be performed by any known method, such as heating by conduction, convection, induction, spot heating, infrared, microwave, or radiant heating. Devices for increasing the temperature of the article in order to perform the processes described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape can be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the crosslinking points of the polymer network so as to remove any stresses caused by application of the mechanical force. A sufficient heating time makes it possible to completely cancel these stresses internally to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain shapes resulting from twisting by molding.

According to one variant, a process for obtaining and/or repairing an article based on a dynamic cross-linked polymer composition described herein comprises: placing in contact with each other two articles or parts of an article formed from a dynamic cross-linked polymer composition; and heating the two articles or parts of the article so as to obtain a single article or part. The heating temperature (T) is generally within the range from about 50° C. to about 250° C., including from about 100° C. to about 200° C.

An article made of dynamic cross-linked polymer compositions as described herein can also be recycled by direct treatment of the article, for example, the broken or damaged article can be repaired by means of a transformation process as described above and can thus regain its prior working function or another function. Alternatively, the article can be reduced to particles by application of mechanical grinding, and the particles thus obtained can then be used to manufacture a new article.

The following examples are provided to illustrate compositions, processes, and properties described herein. The examples are merely illustrative and are not intended to limit the disclosure to the materials, conditions, or process parameters set forth therein.

### EXAMPLES

### Example 1

D.E.R.™ 671 (Dow) was combined with PRIPOL™ 1009 (Croda, Gouda, the Netherlands) and zinc acetylacetonate (10 mol. %). The resulting dynamic cross-linked polymer composition mixture was compression molded into an A4-size sheet with a thickness of about 1 mm. The dynamic cross-linked polymer compositions had a Tg of 41° C.

### Example 2

The A4-size sheet from Example 1 was vacuum thermoformed into a part after applying a heat source (180° C.) for less than 20 seconds.

It is envisioned that the part could have been formed after only about 5 seconds of heating at 180° C. Heating times will vary, depending on the composition of the dynamic cross-linked polymer composition. But heating times will be about 30 to about 60 seconds for a 1 mm sheet. This is a significant reduction in heating time, as compared to other polymer compositions.

### Example 3A

Polymer compositions of the description can be prepared by blending the components in an extruder. For example, the components can be compounded using a Werner & Pfleiderer Extruder ZSK 25 mm co-rotating twin-screw extruder with the settings set forth in the Table below using the following residence times: 2.4 minutes, 4.2 minutes, 6.8 minutes, and 8.7 minutes.

TABLE 1
Compounding Settings

| Extruder | 25 mm ZSK Extruder | |
|---|---|---|
| Die | 2 | hole |
| Feed Temp | 40° | C. |
| Zone 1 Temp | 70° | C. |
| Zone 2 Temp | 190° | C. |
| Zone 3 Temp | 240° | C. |
| Zone 4 Temp | 270° | C. |
| Zone 5 Temp | 270° | C. |
| Zone 6 Temp | 270° | C. |
| Zone 7 Temp | 270° | C. |
| Zone 8 Temp | 270° | C. |
| Die Temp | 270° | C. |
| Screw Speed | 300 | rpm |
| Throughput | 15-20 | kg/hr |
| Vacuum 1 | −0.8 | bar |

### Example 3B

Polymer compositions of the description can be prepared by blending the components in an extruder. For example, the components can be compounded using a Werner & Pfleiderer Extruder ZSK 25 mm co-rotating twin screw extruder with the settings set forth in the Table below.

TABLE 2
Compounding settings

| Extruder | Units | Parameter |
|---|---|---|
| Die | — | 2 hole |
| Feed Temp | ° C. | 40 |
| Zone 1 Temp | ° C. | 70 |
| Zone 2 Temp | ° C. | 220 |
| Zone 3 Temp | ° C. | 240 |
| Zone 4 Temp | ° C. | 270 |
| Zone 5 Temp | ° C. | 260 |
| Zone 6 Temp | ° C. | 260 |
| Die Temp | ° C. | 260 |
| Screw speed | rpm | 450 |
| Throughput | kg/hr | 31 |
| Vacuum 1 | bar | −0.8 (full vacuum) |

### Example 4

PBT (PBT315, by SABIC) was combined with D.E.R.™ 671 (Dow), zinc(II) acetylacetonate (Sigma-Aldrich), and Irganox 1010 anti-oxidant (BASF) at different compositions, as shown in Table 3 (Ex1, Ex2 and Ex3). The components were blended and reacted using the reactive extrusion method as described in Example 3B. After compounding, the pre-DCN compound pellets were compression molded into an A4-sized sheet with a thickness of about 2 mm.

TABLE 3
Compositions (wt. %) of samples for thermoformins experiments.

| | Ex1 | Ex2 | Ex3 | CE4 |
|---|---|---|---|---|
| PBT 315 | 98.1 | 96.6 | 94.6 | 99.9 |
| D.E.R. ™ 671 | 1.56 | 3.07 | 5.07 | |
| Zn(acac)₂ | 0.24 | 0.24 | 0.24 | |
| Irganox 1010 | 0.10 | 0.10 | 0.10 | 0.10 |
| | 100 | 100 | 100 | 100 |

As a comparative example, neat PBT315 resin (composition CE4 in Table 1) was also attempted in thermoforming to make an A4-sized sheet of about 2 mm thickness.

### Example 5

The sheets of Example 4 were then used in a vacuum thermoforming experiment to form an exemplary thermoformed part. In the thermoforming experiments, the sheets were first heated to 220° C. Subsequently, a mold was lifted and imprinted into the heated polymer sheet and the material was thermoformed to conform the mold contours in less than 30 seconds by applying a vacuum.

DCN formulations Ex1 to Ex3 can be thermoformed with reasonable to good or even excellent replication of the mold shape. Furthermore, these materials could be thermoformed at temperatures well above their Tg values (about 46° C.), which is typically not possible for thermoplastic polymers, which typically have a sudden drop in viscosities at temperatures above Tg. At low epoxy cross-linker level (Ex1), the material has gained significantly in melt strength (i.e., the melt viscosity is sufficiently high) as compared to the neat PBT315 polymer (CE4), but does not yet possess significant elasticity (i.e., value of the rubber plateau modulus as measured by DMA) to form a consistent part. However, at higher epoxy cross-linker levels (Ex2), the mold shape is perfectly reproduced upon applying the vacuum thermoforming step. Further increasing the epoxy cross-linker level (Ex3) gives a material with an elasticity that is even too high for proper forming under the current applied vacuum. However, it is envisioned that when thermoforming equipment specifications would allow for higher vacuum levels to be applied, this part could also be replicated perfectly.

In contrast, neat PBT315 polymer (CE4) has no melt strength under the applied temperatures in this vacuum thermoforming experiment, so that it cannot be thermoformed; instead, the polymer melt loses its shape stability and sacks under its own weight to form a hole in the center of the compression molded sheet.

In these, and similar thermoforming experiments, heating times will vary, depending on the composition of the dynamic cross-linked polymer composition. Typically, heating times will be about 30 to about 60 seconds for a 2 mm sheet. This is a significant reduction in heating time, as compared to other polymer compositions.

### Example 6

Dynamic cross-linked polymer compositions and pre-dynamic cross-linked polymer compositions that also include additives, for example glass fiber wool, can be used. One such composition can be prepared by combining PBT, D.E.R. 671, zinc(II)acetylacetonate, and glass fiber wool, as set forth in the following table.

TABLE 4
Combinations of PBT, D.E.R. 671, PE,
zinc(II)acetylacetonate, and glass fiber

| Description | Ex. 6 | Ex. 7 | Ex. 8 | Ex. 9 | Ex. 10 | Ex. 11 |
|---|---|---|---|---|---|---|
| PBT315, milled | 98.9 | 93.7 | 83.9 | 78.7 | 68.9 | 63.7 |
| DER 671 Epoxy Resin | 0.0 | 5.0 | 0.0 | 5.0 | 0.0 | 5.0 |
| PE (ld), milled 1000 μm | 1 | 1 | 1 | 1 | 1 | 1 |
| Antioxidant 1010 | 0.1 | 0.1 | 0.1 | 0.1 | 0.1 | 0.1 |
| Zinc (II) Acetylacetonate | 0.0 | 0.2 | 0.0 | 0.2 | 0.0 | 0.2 |
| Glass fiber wool | 0.0 | 0.0 | 15 | 15 | 30 | 30 |

The various combinations shown in Table 4 can be compounded using a Werner & Pfleiderer Extruder ZSK 25 mm co-rotating twin-screw extruder with the settings set forth in Table 5.

TABLE 5
Compounding Settings

| Extruder | Units | Parameter |
|---|---|---|
| Die | — | 2 hole |
| Feed Temp | ° C. | 50 |
| Zone 1 Temp | ° C. | 150 |
| Zone 2 Temp | ° C. | 240 |
| Zone 3 Temp | ° C. | 260 |
| Zone 4 Temp | ° C. | 250 |
| Zone 5 Temp | ° C. | 240 |
| Zone 6 Temp | ° C. | 240 |
| Zone 7 Temp | ° C. | 240 |
| Zone 8 Temp | ° C. | 240 |
| Zone 9 Temp | ° C. | 250 |
| Die Temp | ° C. | 260 |
| Screw Speed | rpm | 300 |
| Throughput | kg/h | 25 |
| Torque | % | 70-80 |
| Vacuum | bar | max |

### Example 7

Dynamic cross-linked polymer compositions and pre-dynamic cross-linked polymer compositions that also include additives, for example glass fiber wool, can be used. In one such example, the components set forth in the following Table 6 were mixed and compounded on a Werner-Pfleiderer ZSK25 twin-screw extruder (diameter=25 mm) at a melt temperature of 270° C. and a throughput of 18 kg/hour. Glass fibers were fed separately to the blend using a side feeder.

TABLE 6

| Item | Ex1 | Ex2 | Ex3 | Ex4 | Ex5 | CE6 | CE7 |
|---|---|---|---|---|---|---|---|
| PET resin | 85.6 | 85.6 | 85.65 | 85.63 | 85.665 | 85.7 | 88.9 |
| DER 671 epoxy | 3.2 | 3.2 | 3.20 | 3.2 | 3.2 | 3.2 | |
| Zn(acac)₂•H₂O | 0.1 | | | | | | |
| Zn(lactate)₂•H₂O | | 0.1 | 0.05 | | | | |
| ZnO | | | | 0.07 | 0.035 | | |
| Irganox 1010 | 0.1 | 0.1 | 0.1 | 0.1 | 0.1 | 0.1 | 0.1 |
| PE (polyethylene) | 1 | 1 | 1 | 1 | 1 | 1 | 1 |
| PBT glass fibers (10 μm) | 10 | 10 | 10 | 10 | 10 | 10 | 10 |
| | 100 | 100 | 100 | 100 | 100 | 100 | 100 |

### Example 8

Dynamic cross-linked polymer compositions and pre-dynamic cross-linked polymer compositions that also include additives, for example fibrillar PTFE, can be used. Table 7 provides the formulations of samples 1-6. Reference sample 1 contains no cross-linking agent (DER™ 671).

TABLE 7
Combinations of PBT, D.E.R. 671, PE,
zinc(II)acetylacetonate, and PTFE

| Description | Ex. 1 | Ex. 2 | Ex. 3 | Ex. 4 | Ex. 5 | Ex. 6 |
|---|---|---|---|---|---|---|
| PBT315, milled | 98.9 | 93.7 | 83.9 | 78.7 | 68.9 | 63.7 |
| DER ™ 671 Epoxy Resin | 0.0 | 5.0 | 0.0 | 5.0 | 0.0 | 5.0 |
| PE (ld), milled 1000 μm | 1 | 1 | 1 | 1 | 1 | 1 |
| Antioxidant 1010 | 0.1 | 0.1 | 0.1 | 0.1 | 0.1 | 0.1 |
| Zinc (II) Acetylacetonate | 0.0 | 0.2 | 0.0 | 0.2 | 0.0 | 0.2 |
| PTFE | 0 | 0 | 0.5 | 0.5 | 5.0 | 5.0 |

The various combinations shown in Table 5 were compounded using a Werner & Pfleiderer Extruder ZSK 25 mm co-rotating twin screw extruder with the settings set forth in Table 8.

TABLE 8
Compounding Settings

| Extruder | Units | Parameter |
|---|---|---|
| Die | | 2 hole |
| Feed Temp | ° C. | 40 |
| Zone 1 Temp | ° C. | 70 |
| Zone 2 Temp | ° C. | 220 |
| Zone 3 Temp | ° C. | 240 |
| Zone 4 Temp | ° C. | 270 |
| Zone 5 Temp | ° C. | 260 |
| Zone 6 Temp | ° C. | 260 |
| Die Temp | ° C. | 260 |
| Screw speed | rpm | 450 |
| Throughput | kg/hr | 31 |
| Vacuum 1 | bar | −0.8 (full vacuum) |

Unless indicated otherwise, all tests are the version in effect in 2014.

The present disclosure is further illustrated by the following embodiments, which are non-limiting.

### Embodiment 1

A method for forming a compression molded article comprising: introducing a polymer composition that is a dynamic cross-linked polymer composition or a pre-dynamic cross-linked polymer composition into a compaction device comprising a compression mold; and subjecting the polymer composition in the compression mold to a temperature of about 0 to about 100° C. above the glass transition temperature or melting temperature of the polymer composition; wherein the polymer composition is produced by combining an epoxy-containing component, a polyester component, and a transesterification catalyst. In some aspects of Embodiment 1, the polymer compositions is a pre-dynamic cross-linked polymer composition where no crosslinking has occurred. In other aspects of Embodiment 1, the polymer compositions is a pre-dynamic cross-linked polymer composition where partial crosslinking has occurred.

### Embodiment 2

The method of Embodiment 1, further comprising curing the compression molded article.

### Embodiment 3

The method of Embodiment 1 or Embodiment 2, wherein the polymer composition has a glass transition temperature of about 40 to about 60° C.

### Embodiment 4

The method of any one of the preceding Embodiments, wherein the epoxy-containing component is a bisphenol A diglycidyl ether.

### Embodiment 5

The method of the preceding Embodiments, wherein the polyester component is a polyalkylene terephthalate.

### Embodiment 6

The method of any one the preceding Embodiments, wherein the transesterification catalyst is present at about 0.025 mol % to about 25 mol %, based on the total moles of ester groups in the polyester component.

### Embodiment 7

The method of any one of the preceding Embodiments, wherein the transesterification catalyst is zinc(II)acetylacetonate.

### Embodiment 8

The method of any of the preceding Embodiments, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

### Embodiment 9

An article prepared according to a method of any of the preceding Embodiments.

### Embodiment 10

A method of forming a vacuum thermoformed article comprising: feeding a sheet comprising a polymer composition that is a dynamic cross-linked polymer composition or a pre-dynamic cross-linked polymer composition to a mold; heating the sheet for up to about 120 seconds; and applying a vacuum to the heated sheet to form the vacuum thermoformed article; wherein the polymer composition is produced by combining an epoxy-containing component, a polyester component, and a transesterification catalyst.

### Embodiment 11

The method of Embodiment 10, wherein the sheet is heated to a temperature of up to about 200° C.

### Embodiment 12

The method of Embodiment 10 or Embodiment 11, wherein the sheet is heated for about 5 to about 60 seconds.

### Embodiment 13

The method of any one of Embodiments 10 to 12, wherein the epoxy-containing component is a bisphenol A diglycidyl ether.

### Embodiment 14

The method of any one of Embodiments 10 to 13, wherein the polyester component is polybutylene terephthalate.

### Embodiment 15

The method of any one of Embodiments 10 to 14, wherein the transesterification catalyst is present at about 0.025 mol % to about 25 mol %, based on the moles of ester groups in the polyester component. The method of any one of Embodiments 10 to 15, wherein the transesterification catalyst is zinc(II)acetylacetonate.

### Embodiment 16

The method of any one of Embodiments 10 to 16, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

### Embodiment 17

An article prepared according to a method of any one of Embodiments 10 to 17.

### Embodiment 18

The method or articles of any one of the preceding Embodiments 1 to 17, wherein a carboxylic acid component is used in addition to, or in place of, the polyester component.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method for forming a compression molded article comprising:
introducing a polymer composition that is a dynamic cross-linked polymer composition or a pre-dynamic cross-linked polymer composition into a compaction device comprising a compression mold; and
subjecting the polymer composition in the compression mold to a temperature of about 0 to about 100° C. above the glass transition temperature or melting temperature of the polymer composition;
wherein the polymer composition is produced by combining an epoxy-containing component, a polyester component, and a transesterification catalyst.

2. The method of claim 1, further comprising curing the compression molded article.

3. The method of claim 1, wherein the polymer composition has a glass transition temperature of about 40 to about 60° C.

4. The method of claim 1,
wherein the epoxy-containing component is a bisphenol A diglycidyl ether.

5. The method of claim 1, wherein the polyester component is a polyalkylene terephthalate.

6. The method of claim 1, wherein the transesterification catalyst is present at about 0.025 mol % to about 25 mol %, based on the total moles of ester groups in the polyester component.

7. The method of claim 1, wherein the transesterification catalyst is zinc(II)acetylacetonate.

8. The method of claim 1, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

9. An article prepared according to the method of claim 1.

10. A method of forming a vacuum thermoformed article comprising:
feeding a sheet comprising a polymer composition that is a dynamic cross-linked polymer composition or a pre-dynamic cross-linked polymer composition to a mold;
heating the sheet for up to about 120 seconds; and
applying a vacuum to the heated sheet to form the vacuum thermoformed article;
wherein the polymer composition is produced by combining an epoxy-containing component, a polyester component, and a transesterification catalyst.

11. The method of claim 10, wherein the sheet is heated to a temperature of up to about 200° C.

12. The method of claim 10, wherein the sheet is heated for about 5 to about 60 seconds.

13. The method of claim 10, wherein the epoxy-containing component is a bisphenol A diglycidyl ether.

14. The method of claim 10, wherein the polyester component is polybutylene terephthalate.

15. The method of claim 10, wherein the transesterification catalyst is present at about 0.025 mol % to about 25 mol %, based on the moles of ester groups in the polyester component.

16. The method of claim 10, wherein the transesterification catalyst is zinc(II)acetylacetonate.

17. The method of claim 10, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

18. An article prepared according to the method of claim 10.
